(19) United States
(12) Patent Application Publication
(10) Pub. No.: US 2024/0210934 A1
(43) Pub. Date: Jun. 27, 2024

(54) REMAINING USEFUL LIFE ESTIMATION USING HYBRID PHYSICS-MACHINE LEARNING REASONING

(71) Applicant: PALO ALTO RESEARCH CENTER INCORPORATED, Palo Alto, CA (US)

(72) Inventors: Amirhassan Abbasi, Philadelphia, PA (US); Kai Frank Goebel, Mountain View, CA (US)

(21) Appl. No.: 18/086,325

(22) Filed: Dec. 21, 2022

(51) Int. Cl. G05B 23/02; G06N 3/0985

(52) U.S. Cl. CPC G05B 23/0283; G06N 3/0985

(57) ABSTRACT

Condition-monitoring data of an engineering system is received at a computing system. The condition-monitoring data is input to a hybrid model that includes a machine learning model empowered with physics-informed transfer functions on the computing system. The machine learning model outputting a prediction of health variables of the engineering system as intermediate variables. These variables are transformed via mathematically parametrized transfer functions on the computing system. A remaining useful life of the engineering system is estimated based on the transformation outputs. The remaining useful life is used to perform a remedial action on the engineering system.

### SUMMARY

The present disclosure is directed to a system and method of remaining useful life estimation using hybrid physics-machine learning reasoning. In one embodiment, condition-monitoring data of an engineering system is received at a computing system. The condition-monitoring data is input to a hybrid model that includes a machine learning model empowered with physics-informed transfer functions on the computing system. The machine learning model outputs a prediction on health variables of the engineering system as intermediate variables. These variables are transformed via mathematically parametrized transfer functions on the computing system into an estimation of the remaining useful life of the system. Estimation of remaining useful life is used to perform a remedial action on the engineering system.

In another embodiment, condition-monitoring data collected from an engineering system is received at a computing system. During a healthy stage of the engineering system, the first health stage indicator of the engineering system is estimated based on the condition-monitoring data. The first transition in the health condition of the engineering system is detected from the healthy stage to a quasi-linear degradation stage using the first health stage indicator. During the further loading and consequent degradation, a second health stage indicator of the engineering system is estimated using condition monitoring data that is different from the first health indicator. A second transition of the engineering system from the quasi-linear health stage to accelerated degradation condition is detected using the second health indicator. During the accelerated degradation, features of the condition-monitoring data are extracted and input to a hybrid model, which is a machine learning model empowered with physics-informed transfer functions. The initial part of the hybrid model outputs intermediate variables which are prediction on health variables of the engineering system. In the second part of the hybrid model, the mathematically parametrized transfer functions are applied to the intermediate variables of the hybrid model. The remaining useful life of the engineering system is estimated based on the outputs of this physics-inspired transformation. The remaining useful life is used to perform a remedial action on the engineering system.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a block diagram of a generic prognostics system according to an example embodiment;

FIG. 2 is a diagram of health stages used in prognosis according to an example embodiment;

FIG. 3 is a block diagram showing a framework of a hybrid prognostics model according to an example embodiment;

FIG. 4 is a block diagram showing details of a hybrid prognostics model according to an example embodiment;

FIG. 5 is a flowchart illustrating steps of prognostics reasoning according to an example embodiment; and

FIGS. 6-8 are plots showing experimental results for a hybrid prognostics model according to an example embodiment.

### DETAILED DESCRIPTION

The present disclosure is generally related to a system and method for prognosis reasoning, e.g., estimating remaining useful life (RUL) of engineering assets, systems, sub-systems, components, etc., based on hybrid physics machine learning reasoning.

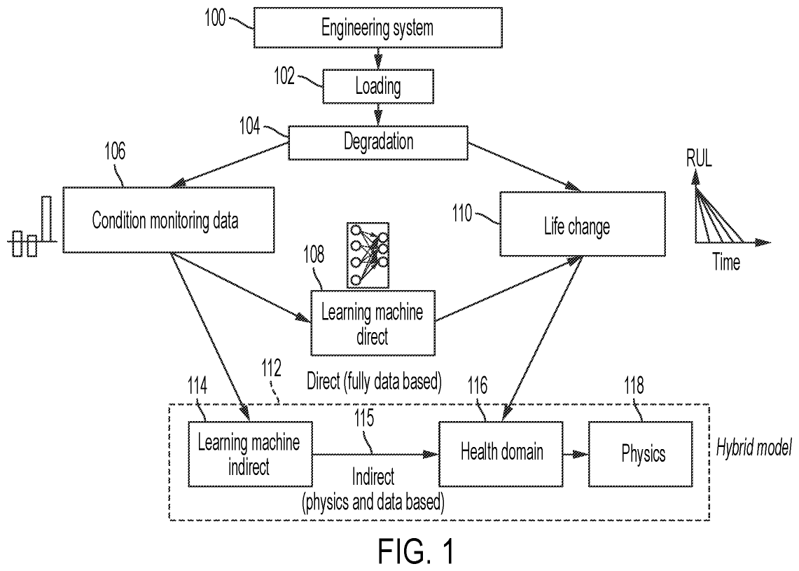

Rapid advances in a broad range of engineering domains have intensified demands for prognostics and health management. Prognostics can enhance engineering systems' productivity, reliability, maintainability, and safety. In FIG. 1, a block diagram shows a prognostics system according to an example embodiment. An engineering system 100 is subject to loading 102 and degradation 104 during operation. A processor implemented apparatus collects condition monitoring data 106 from sensors, e.g., accelerometers, thermal sensors, optical sensors, rotation/speed sensors, voltage/current sensors, etc. In a direct data-driven approach, the condition monitoring data 106 is input to a machine learning model 108, and the output of model 108 is a life change 110. In an indirect hybrid approach 112, a hybrid model including a machine learning model (114) empowered with physics is used. The outputs 115 of this machine learning model are variables of a health domain 116 that may be physics-inspired, as indicated by block 118. Then, the hybrid model transfers health domain information to life change. In other words, in the direct approach, a mapping between collected data and life change is developed directly. In contrast, this mapping passes through an intermediate health domain in the indirect approach.

The life change 110 predicted by either method can be used for prognosis reasoning and performing remedial actions, e.g., scheduling maintenance, replacing or retiring components/sub-systems, etc.

The primary component of prognosis reasoning is modeling a target system's change of health/life, which is typically in the absence of maintenance, degrading as a function of operational and environmental conditions. There are different criteria for selecting an optimum modeling approach for prognostics. Physics-based approaches capture the degradation process in a generic mathematical framework based on deductive reasoning and empirical data. However, there are issues with the development and applicability of physics-based models. For example, understanding the physics of many fault modes and their progression is not straightforward. Simplifying assumptions that are used in the models result in deviation between their predictions and observations. Also, they reduce the accuracy of models. In addition, developing physics-based models can be expensive and tedious, and model development benefits may not justify the effort. However, physics-based models show high capability in generalization, error quantification, and robustness.

Data-driven models develop mathematical relationships between observations of sensor measurements and desired outcomes (like the end of life) purely based on data. This characteristic reduces the need for a detailed understanding of the underlying physics. These models' performance is highly dependent on the availability of historical data. Lack of a sufficient number of run-to-failure data and the high cost of deploying sensing technology limit their performance in many real-work applications. These issues undermine their ability to generalize and predict in unseen conditions.

This disclosure proposes a method and system for hybrid physics machine learning reasoning that combines the advantages of physics-based and data-driven modeling while avoiding shortcomings. This involves integrating knowledge about the physics of degradation into learning from data for prognosis reasoning. This knowledge originates from common and fundamental degradation modes widely observed in the degradation of various engineering systems. It is integrated at two levels. The first, hypothesizing a physics-inspired health domain and health stage division. Second, mathematically parametrizing a health indicator (HI) and evolving it over time for transferring the health information to the life domain and RUL estimation.

A relationship between observations on the degradation of a system and its life variation can be developed using direct and indirect approaches. In the direct approach, condition monitoring data are mapped directly to the life domain in a single-step process. In contrast, in the indirect approach, data are mapped to a health domain, including a health indicator (HI) in the primary step. HI variation over time is mapped to the life domain in the second step.

Although the first approach provides simplicity and ease of reasoning, it encounters practical issues in real-world applications for several reasons. In general, engineering systems may undergo different degradation modes over their lifetime, and each may be active at different health stages or time scales. The multi-factorial nature of degradation causes complexity, which is also reflected in observations/sensors data. On the other hand, life variation generally is measured linearly based on the unit of measurement of usage (e.g., cycle, day, month, etc.). Mapping data/observations directly to the linear domain of life is not trivial for data-driven algorithms due to the complexity of mapping, high demands for data, and numerous data-processing steps.

In the indirect mapping, the relationship between the observation/sensor domain and life domain is developed in two steps. These two reasoning steps provide facility for model development, performance improvement, and incorporating domain knowledge about the degradation. This knowledge can be obtained from the physics of degradation and used for different purposes. Embodiments described herein focus on two primary goals.

Firstly, a physics-inspired health domain and health stage (HS) division are hypothesized. This health domain can represent the evolution of different degradation modes. These fundamental degradation modes are considered because of their high correlation with field observations and experiments. These modes are called fundamental since they are observed over various engineering systems. Regardless of different root causes in different systems, they are the unifying part of degradation in different systems. The fundamental degradation modes can be separated into different phases according to the time rate of degradation progression.

The time rate of degradation progression is an indicator of the underlying degradation mechanism and the severity of degradation. Hence, it can optimize/amplify the prognostics models/algorithms inputs. Specifically, narrowing the input domain of prognostics models to the final range experiencing a high degradation rate improves the RUL estimation performance. The high degradation rate shows that the degradation has advanced to the point where it significantly affects the health condition. Hence, the information content of data/observation is relatively high in this condition which can be helpful for prognosis reasoning.

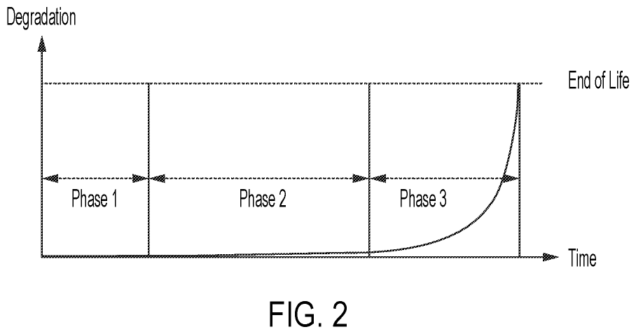

Secondly, a prognostics framework, according to example embodiments, mathematically parametrizes a health indicator in the target health domain (e.g., Phase 3 in FIG. 2). This health indicator is used as a transfer function for transferring the information in the health domain to the life domain. This parametric step facilitates incorporating different assumptions about rate and form of degradation into the prognostics reasoning. This intermediate step can address the issues discussed in the direct approach.

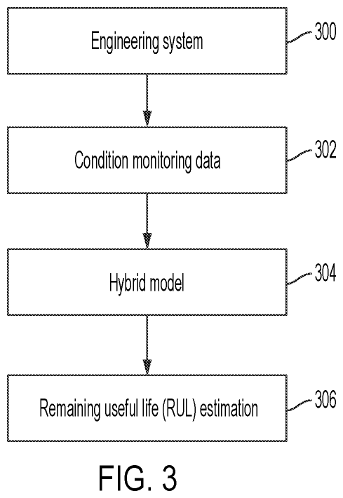

The disclosed embodiments provide the advantages of the indirect approach and integrate the two steps to develop a hybrid prognostics model. In FIG. 3, a block diagram shows a high-level summary of this framework. Generally, condition-monitoring data 302 of an engineering system 300 is input to a hybrid model 304. Model 304 is hybrid since it integrates physics and machine learning. It receives the condition monitoring data 302 and, in response, outputs estimation of remaining useful life 306 of the engineering system 300. Further details are discussed in the following sections.

The health condition of an engineering system will experience different degradation trends due to various degradation modes over its lifetime. These modes may overlap or act at different time scales and manifest with different symptoms. It should be noted that the damage variable in many engineering systems is not directly observable from condition monitoring data. Hence, to simplify the prognosis reasoning, a health domain is assumed that abstracts the health variation of the system. The variation of health in this domain, represented by a health indicator, is assumed to be demonstrative of the degradation progression and is used for prognostic reasoning. This variation also can be used for determining the main health stages of the system over the lifetime. This health domain can be abstracted based on the different assumptions on the form of degradation progression, such as linear or nonlinear. These assumptions can be made based on physics and can be supported by observations from the physics of degradation in real-world engineering systems. Hence, the current invention hypothesizes a physic-inspired health domain that can be observed in the degradation of many engineering systems. A fundamental degradation mode governs the health variation in this domain. It is the unifying physics-inspired component of degradation shared between a broad range of systems.

An example of different health domains that may be used in various embodiments is shown in FIG. 2. This health domain includes a commonly used fundamental degradation mode. The health domain is separated into different health stages noted by sequential phases. The curve represents a degradation progression along loading time (which is corresponding to HI reduction) that is divided into three phases. These phases are categorized based on the time rate of degradation progression. In the first phase (sometimes referred to as a healthy phase), there is no abnormality, and the system is healthy. In the second phase (sometimes referred to as an intermediate phase), deterioration has started, and degradation incubation occurs. It is slow and quasi-linear and not informative about remaining life. At a transition point, called the elbow point, system health enters Phase 3 (sometimes referred to as a critical phase, or accelerated degradation condition). The last phase is dominated by accelerated wear/degradation where the fault has been advanced enough such that critical symptoms of degradation can be observed. The degradation in Phase 3 propagates significantly faster than in Phase 2. Note that some health stage division strategies may only use two stages, e.g., a healthy stage and an unhealthy stage, and embodiments below may also be applicable to a two-stage condition as well.

One or more embodiments use the explained physics-inspired health stage division to optimize the information content of the prognostics model by narrowing down the input domain to Phase 3. In other words, the collected data in Phase 1 and Phase 2 are not informative about the remaining life of the system, given the low severity and progression rate of degradation. Hence, the collected data from Phase 3 are used for prognosis reasoning and RUL estimation.

As explained earlier, the indirect prognostics approach provides flexibility for integrating domain knowledge in the prognostics reasoning. In detail, a mathematically parametrized HI can be defined that serves as a transfer function from the health domain to the life domain. The domain knowledge can be used to determine the form and rate of the HI. As discussed earlier, this invention assumes a physics-inspired form for the HI. Based on the discussed health stages division, this HI is supposed to represent the health variation in the accelerated phase. In one or more embodiments, it is assumed that HI will be nonlinear and convex so that the degradation rate increases with fault development. An exponential function can parametrize it. An example of this degradation can be observed in fatigue crack growth formulated by Paris law. The HI equation is written as follows.

$$HI ( t ) = {ae}^{bt} + c \qquad ( 1 )$$

where a, b, and c are parameters of HI and t shows the time. Denoting the initial and final value of HI with HIᵢ and HI_{f}, respectively and the total life of the system by T results in,

$$a = {HI}_{i} - c \qquad ( 2 )$$

$$b = \frac{1}{T} ln ( \frac{{HI}_{f} - c}{{HI}_{i} - c} ) \qquad ( 3 )$$

Accordingly, Eq. 1 can be rewritten as follows.

$$HI ( t ) = {( {HI}_{i} - c ) [ \frac{{HI}_{f} - c}{{HI}_{i} - c} ]}^{\frac{t}{T}} + c \qquad ( 4 )$$

Without loss of generality, it is assumed that HI varies in a range with an upper bound of 1 which indicates a healthy condition and a lower bound of 0 which shows the end-of-life threshold. Accordingly, the total lifetime (T) can be obtained as follows.

$$T = \frac{t ln ( \frac{c}{c - 1} )}{ln ( \frac{HI ( t ) - c}{1 - c} )} \qquad ( 5 )$$

Then, the RUL is calculated as follows.

$$R U L = T - t \qquad ( 6 )$$

Eq. 6 can be expanded as,

$$R U L = \frac{t ln ( \frac{c}{c - 1} )}{ln ( \frac{HI ( t ) - c}{1 - c} )} - t \qquad ( 7 )$$

It can be seen that the RUL depends on the c, which affects the degradation rate, current health value (HI(t)), and current time (t). In order to obtain a physically reasonable health indicator, an additional constraint is imposed. To have a nonlinear convex health variation so that the degradation rate increases as time passes, c value is assumed to be greater than one in a normalized health domain where HI varies in a range with an upper bound of 1 and a lower bound of 0.

Although the formulated HI is supported by physical observations, there is no restriction on its form. In fact, other forms of HI can be assumed based on statistical properties of data or learning algorithm performance, which may not have a physical interpretation. For example, a linear HI can be assumed as follows.

$$HI ( t ) = a t + b \qquad ( 8 )$$

That similarly can be written as,

$$HI ( t ) = ( \frac{{HI}_{f} - {Hi}_{i}}{T} ) t + {HI}_{i} \qquad ( 9 )$$

Accordingly, RUL can be calculated as follows.

$$R U L = ( \frac{{HI}_{f} - {HI}_{i}}{HI ( t ) - {HI}_{i}} ) t - t \qquad ( 10 )$$

The simplified form can be written as follows.

$$R U L = \frac{t}{1 - HI ( t )} - t \qquad ( 11 )$$

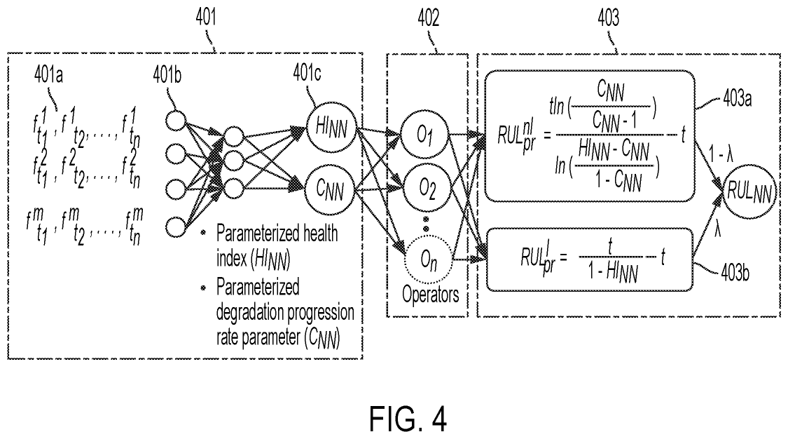

In the proposed prognostics model, the two steps of the indirect prognostics approach are integrated into a unified learning algorithm in the hybrid model. The schematic of the model can be seen in FIG. 4. It should be noted that inputs of this model ([fₜ_{₁}ⁱ, . . . , fₜ_{ₙ}ⁱ], i=1, . . . , m) are selected from the collected data from the last phase of degradation (Phase 3 in FIG. 2) according to the physics-inspired health division. This model has three parts 401-403.

The objective of part 401 is parametrizing a generic HI (HI_{NN}) and degradation progression rate parameter (c_{NN}) by learning from data using a machine learning model 401b. As an example, a neural network can be considered for this purpose. This part maps the collected data (or engineered features) from the accelerated degradation phase (401a) to these values 401c. In fact, this data-driven part maps the observation domain to the health domain.

The second part (block 402) performs mathematical or logical manipulations using a set of operations (O₁, O₂, . . . , Oₙ) to make the outputs of the first part physically plausible and usable for the next part of the model (block 402). For example, to have a convex degradation progression c value should always be larger than one in a normalized health domain where HI lower and upper bounds are 0 and 1, respectively. Thus, mathematical operations modify the range of values and impose this condition. Also, the reasoning may require additional manipulations given the mathematical formulations used in the third part (block 403). They can include arithmetic operations and/or logarithmic transformation.

The last part (block 403) concerns using mathematically parametrized health indicators and transferring the health information to the life domain. Two transfer functions perform this task. The first transfer function (block 403a) transfers HI value (HI_{NN}) and degradation progression rate parameter (c_{NN}), which are obtained by the learning algorithm in the first part, to the life domain using the function in Eq. 7 providing a first estimate of the RUL. As explained earlier, this function is supported by physical evidence from the degradation of a broad range of engineering systems and experiments.

The second transfer function (block 403b) transfers the health HI_{NN} to the life domain by a linear relationship using Eq. 11 to obtain a second estimate of RUL. Considering this part in the final step may improve the performance of the learning algorithm. The estimations of these two transfer functions are combined using a weight factor (λ), and a compound loss function is considered for the algorithm as:

$$Loss = λ {MSE}_{l} + ( 1 - λ ) M S {E}_{n l} \qquad ( 12 )$$

where MSEₗ and MSEₙₗ are mean square errors obtained from the linear (block 403a) and nonlinear part (block 403b), respectively. The error terms accordingly are defined as follows.

$${E}_{l} = \frac{1}{n} {\sum }_{i = 1}^{n} {[ R U {L}_{N {N}_{i}}^{l} - R U {L}_{G {T}_{i}} ]}^{2} \qquad ( 13 )$$

$${E}_{n l} = \frac{1}{n} {\sum }_{i = 1}^{n} {[ R U {L}_{N {N}_{i}}^{n l} - R U {L}_{G {T}_{i}} ]}^{2} \qquad ( 14 )$$

where Eₗ and Eₙₗ respectively show the error related to linear and nonlinear parts calculated over n number of ground truth values for remaining useful life (RUL_{GT}) over the training process. It should be noted that Eq. 12 is a general loss function; however, it can be customized based on prognosis requirements. Specifically, underestimation of RUL is preferable to overestimation of RUL. That can be used as a constraint for imposing bias on the learning algorithms for fulfilling this requirement. The weight factor (λ) is considered as a hyperparameter varying between 0 and 1 (λ∈(0,1)) and is set upon hyperparameter optimization.

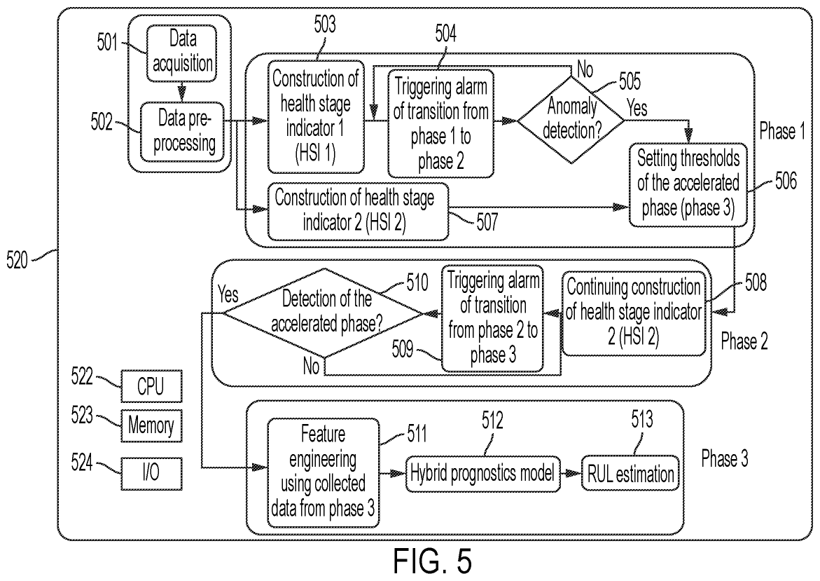

The overall steps of prognosis reasoning according to an example embodiment can be seen in FIG. 5. Block 501 is related to data acquisition. In data acquisition, condition monitoring data such as vibration or acoustic emission signals are captured. Data pre-processing (block 502) concerns transforming the raw data into tractable formats which can be used in further analyses. It includes data scrubbing, data fusion, data transformation, data reduction, and data discretization.

As can be seen in this figure, the physics-inspired health stage division is the basis of the proposed prognostics reasoning. Accordingly, the prognosis algorithm steps/actions are dependent on the current active health stage. Also, the transition of health stages is identified for switching actions and should be detected in real-time during the loading. In some application domains (such as the commercial modular aero-propulsion system simulation (C-MAPSS) dataset), some of the health stages may be integrated into each other and form a unified stage, that requires further modification in prognosis reasoning.

The Phase 1 block concerns the first stage where the system is healthy. In this range, the first health stage indicator (block 503) is constructed using condition monitoring data or their transformation to time (which can be at different scales such as cycle), frequency, or time-frequency domain. In response to the activation of Phase 1, the alarm of transition from Phase 1 to Phase 2 is triggered (block 504). This alarm uses the information in the constructed health stage indicator 1 for detecting the transition of Phase 1 to Phase 2 or anomaly detection. Also, this alarm can be applied based on combining results of different alarms by ensemble techniques such as majority voting and integrating adaptive thresholds and classifiers such as support vector machines. The alarm continuously checks the indicator value till detecting the transition to Phase 2.

In response to this transition, operation in block 506 extracts statistical properties from the other health stage indicator defined in block 507. This indicator will be explicitly used to detect the emergence of the accelerated phase. Based on the extracted statistics, the thresholds of the entrance to Phase 3 (accelerated phase) are set.

After this point, Phase 2 (quasi-linear) is active. In response to the activation of Phase 2, the second health stage indicator is continuously extracted from the condition monitoring data over time (block 508). It is used as the input for the alarm for the transition from Phase 2 to Phase 3 (blocks 509 and 510).

Upon detecting the elbow point which shows the beginning of the accelerated phase (Phase 3), the feature engineering block (block 511) uses the condition monitoring data of the accelerated phase and provides inputs for the hybrid model (block 512). Finally, the hybrid model (see FIG. 4) estimates the RUL (block 513).

The prognosis of rolling element bearings is considered as the case study using a dataset known as FEMTO-PRONOSTIA. The dataset is available for public use and has been generated by Franche-comté Electronics Mechanics Thermal Science and Optics-Sciences and Technologies institute. It includes data of 17 run-to-failure trajectories of rolling element bearings at three different loading and operational conditions acquired from the PRONOSTIA platform. The operating conditions are listed in Table 1.

TABLE 1
operating condition of bearings

| Operating condition | Shaft speed (rpm) | Load (N) |
|---|---|---|
| Case 1 | 1800 | 4000 |
| Case 2 | 1650 | 4200 |
| Case 3 | 1500 | 5000 |

Bearing health is monitored by two types of signals: vibration (horizontal and vertical accelerometer) and temperature. The sampling rate is 25.6 kHz, and data are recorded every 10 s. There is no artificially initiated defect on the bearings, but the applied radial force is higher than the maximum dynamic load, which causes a highly accelerated life test condition. The bearing is assumed to be at end of life when the amplitude of the vibration signal exceeds 20 g.

Several limitations make this prognosis problem difficult. At each operational condition, only two training cases are available, which undermines the statistical significance of the dataset. Even under the same operating condition, the lifetime and degradation of bearings are different, showing high variability in the data. Given the highly dynamic working environment and frequent contacts, degradation incipient of a component can rapidly expand to other internal components. Hence, one can observe the overlap of different fault modes during the run-to-failure process.

In this section, the steps shown in FIG. 5 are used for the case study of rolling element bearing prognosis. Data acquisition (block 501), horizontal and vertical accelerometers are used to record vibration data with measurement details that have already been explained earlier. Data preprocessing (block 502) includes run-in period disposal, outlier detection/removal, noise reduction, data smoothening, and data normalization.

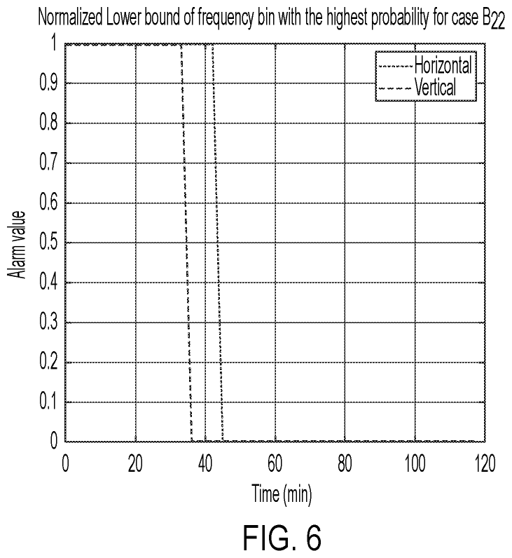

The construction of health stage indicator 1 (block 503) targets defining an indicator for detecting the transition from Phase 1 to Phase 2. For the construction of this indicator, vibration data in vertical and horizontal directions are transformed to the frequency domain by the Fast Fourier Transform (FFT). The indicator represents the change in the frequency of the peak amplitude of the frequency spectrum. In detail, at each measurement cycle, the FFT is applied to vibration data in two directions. Within a window of time, the frequency values of the first three peaks of FFT are identified. The generalized extreme studentized deviate test is used for identifying and removing outliers. Then, the frequencies are partitioned to the bins with normalized probability and a vector of bins edge with 6 equally sampled elements between 0 and 5000. The lower bound of the bin with the highest probability is selected. Upon run-in period disposal, the alarm of transition from Phase 1 to Phase 2 (block 504) detects a change in the value of the lower bound of the bin with the highest probability in either horizontal or vertical vibration data. This change is assumed to indicate the transition to Phase 2. The normalized lower bound of the frequency bin with the highest probability upon this change for a bearing (B22) can be seen in FIG. 6.

Upon detecting this variation (block 505), which is an indicator of incipient of Phase 2, the algorithm moves to the next step (block 506) to set the alarm thresholds of the accelerated phase. For this purpose, it uses the second health stage indicator (HSI 2 in block 507). This indicator is defined from vibration data in the time domain in an accumulative approach. The alarm checks the second gradient of accumulative sub-banded rms (RMS_{ac_s}). Within each window of time, vibration data of each cycle of measurement is decomposed by wavelet pocket decomposition using order 4 Daubechies wavelet (db4). Then, the wavelet packet coefficients are reconstructed, and the corresponding RMS is calculated. These values within the time window are smoothed, then a numerical gradient is calculated (fᵢ). The maximum value of the gradient is selected (max(Δfᵢ)). Then the accumulative sub-banded rms (RMS_{ac_s}) is calculated as follows.

$$R M {S}_{ac \_ s} ( t + 1 ) = R M {S}_{ac \_ s} ( t ) + max Δ {f}_{i} \qquad ( 15 )$$

$$i = 1 , 2 , … , 16$$

where Δfᵢ shows the gradient, and i denotes the corresponding subband. Upon determining the time of transition from Phase 1 to Phase 2, the mean (m_{ac_s}) and standard deviarion (std_{ac_s}) of RMS_{ac_s} up to that time are calculated by the operation in block 6, and the threshold of the accelerated phase is set on m_{ac_s}±5std_{ac_s}.

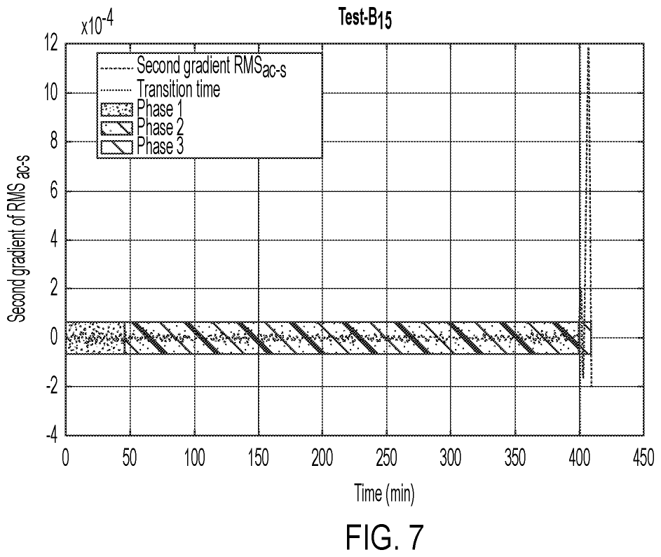

Upon transition to Phase 2, the algorithm continues constructing the second health stage indicator (block 508) and is used for detecting incipient of the accelerated phase (block 9). This alarm skips the initial 6 minutes and calculates the smoothed second gradient of RMS_{ac_s} and once this value for two sequential samples lies out of the range defined in block 6 (m_{ac_s}±5std_{ac_s}) returns a positive response. A positive response of the transition alarm from Phase 2 to Phase 3 shows the start of accelerated degradation (the elbow point). The results of this alarm for test case 5 can be seen in FIG. 7.

The start of this Phase 3 coincides with the first prediction time (FPT). In this phase, the feature engineering applies a set of operations to the condition monitoring data to prepare inputs for the hybrid model. Primarily, features are extracted from the time, frequency, and time-frequency domains. The features in the time domain are accumulative decomposed root mean square (RMS), RMS, skewness, kurtosis, variance, peak to peak, shape factor, crest factor, clearance factor, impulse factor, time series entropy, RMS of the intrinsic mode functions from empirical mode decomposition. Frequency-domain features are: spectrum mean, spectrum RMS, spectrum standard deviation, spectrum kurtosis, spectrum skewness, FFT entropy, Hilbert entropy, ball pass frequency (outer race), ball pass frequency (inner race), fundamental train frequency, and ball spin frequency. The features in the time-frequency domain are energies of eight sub-bands after wavelet packet decomposition. The features are extracted from horizontal and vertical vibrations and are smoothed by a moving average filter. Then, normalization is performed to transfer them to the same scale. Pearson correlation is used for removing the features with high correlation for removing information redundancy and feature reduction. In the next step, further reduction is obtained by the feature ranking based on prognosability, trendability, and monotonicity measures. Feature selection is performed using a wrapper with a sequential forward selection (SFS) search approach.

In the first part of mapping (FIG. 4, block 401), a deep, feedforward neural network is used whose hyperparameters are set by grid search with the search space of: number of hidden layers can be in the range [1, 10], number of neurons at each hidden layer can be in the range [10, 200], and activation function type can include [tan h, ReLu, sigmoid]. The root mean square propagation is used as the optimizer with an initial rate of 0.011 and validation frequency of 12, learning rate drop factor of 0.2, learning rate drop period of 10, maximum epoch number of 3550, and mini-batch size of 80. Operations (FIG. 2, block 402) required for developing the model are keeping the HI value (HI_{NN}) in range (0, 1) that is obtained by a sigmoid function. Also, the degradation progression rate parameter (c_{NN}) should be larger than 1, which is achieved by adding its absolute value to 1 when it is less than 1. The other operators include natural logarithm, division, and subtraction, according to FIG. 4, block 403. The weight factor (λ) is found by a grid search over the range (0, 1) with a step size of 0.02.

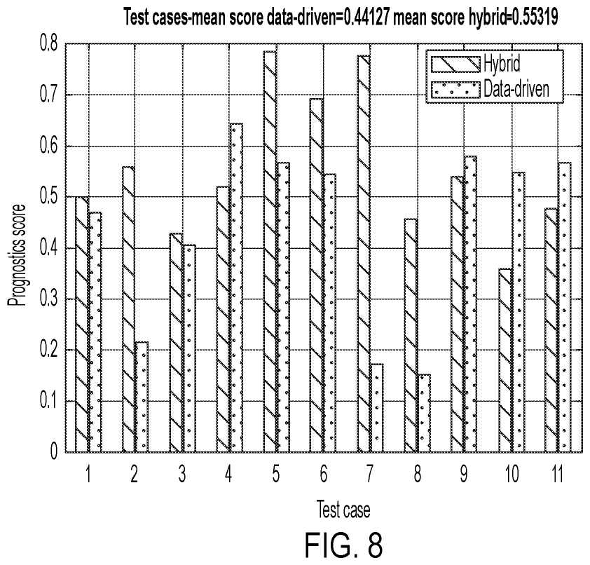

The performance of the developed model is evaluated using the prognosis score proposed by dataset providers. The score is defined as

$$Score = \frac{1}{m} {\sum }_{i = 1}^{m} {A}_{i} \qquad ( 16 )$$

where m shows the number of test cases (m=11) and Aᵢ is defined as follows.

$${A}_{i} = \{ \begin{matrix}{exp}^{- ln ( 0.5 ) ( {E}_{i} / 5 )} , & {E}_{i} \leq 0 \\ {exp}^{- l n ( 0.5 ) ( {E}_{i} / 20 )} , & {E}_{i} > 0\end{matrix} \qquad ( 17 )$$

where Eᵢ is the error and is defined as follows.

$${E}_{i} = \frac{{ACU\_RUL}_{i} - {EST\_RUL}_{i}}{{ACU\_RUL}_{i}} \qquad ( 18 )$$

where ACU_RULᵢ and EST_RULᵢ are actual and estimated RUL, respectively. FIG. 8 shows the result of the proposed approach. The overall score for the hybrid approach and pure data-driven approach is 0.55319 and 0.44127, respectively.

The various embodiments described above may be implemented using circuitry, firmware, and/or software modules that interact to provide particular results. One having skill in the arts can readily implement such described functionality, either at a modular level or as a whole, using knowledge generally known in the art. For example, the flowcharts and control diagrams illustrated herein may be used to create computer-readable instructions/code for execution by a hardware processor. Such instructions may be stored on a non-transitory, computer-readable medium and transferred to the processor for execution as is known in the art. The structures and procedures shown above are only a representative example of embodiments that can be used to provide the functions described hereinabove.

For example, in reference again to FIG. 5, the steps shown in the example can be implemented on a computing system 520 that includes one or more computing apparatuses. These apparatuses may include at least a central processing unit (CPU) 522, volatile or non-volatile, non-transitory memory 523, and input/output (I/O) circuitry 524. These hardware components may be operable via software or firmware instructions transferred from memory 523 to the CPU 522, and interact with an engineering system, sensors, users, etc., via the I/O 524.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality.

Terms related to orientation, such as “top,” “bottom,” “side,” and “end,” are used to describe relative positions of components (e.g., as arranged in the figures) and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiment.

References to a “combination” of different elements is also meant to include each element on its own unless otherwise indicated. For example, a combination of A, B, and C may include any one of A, B, or C alone, as well as A+B, A+C, A+B+C, etc. Further, where the elements of the combinations are actions (e.g., steps of a method), the listing of actions is not meant to imply a specific order that the actions may be taken in the combination unless otherwise indicated.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination and are not meant to be limiting, but purely illustrative. It is intended that the scope of the invention be limited not with this detailed description, but rather determined by the claims appended hereto.

1. A method, comprising:
receiving condition-monitoring data of an engineering system at a computing system;
inputting the condition-monitoring data to a hybrid model that includes a machine learning model empowered with physics-informed transfer functions on the computing system, the machine learning model outputting a prediction of health variables of the engineering system as intermediate variables;
transforming the prediction via mathematically parametrized health domain transfer functions on the computing system; and
estimating remaining useful life of the engineering system based on the transformed prediction data, the remaining useful life used to perform a remedial action on the engineering system.

2. The method of claim 1, wherein the intermediate variables of the hybrid model comprise a health indicator HI and a degradation progression rate c.

3. The method of claim 2, wherein the mathematically parametrized health domain transfer functions comprise an exponential function.

4. The method of claim 3, further comprising imposing a constraint that the degradation progression rate c is larger than 1 to impose a convex degradation progression in a normalized health domain where health index varies in a range with upper and lower bounds of 1 and 0, respectively.

5. The method of claim 2, wherein transforming the prediction comprises:
applying a first transfer function that transfers the health indicator HI and the degradation progression rate c to a life domain using a physics-based relationship to obtain a first estimate of the remaining useful life;
applying a second transfer function that transfers the health indicator HI and the degradation progression rate c to the life domain using a linear relationship to obtain a second estimate of the remaining useful life; and
combining the first estimate and the second estimate using a weight factor to obtain a combined estimate of the remaining useful life.

6. The method of claim 1, further comprising:
measuring a health stage indicator based on the condition-monitoring data to monitor the engineering system during a quasi-linear degradation stage; and
using the health stage indicator, estimating a transition of the engineering system from the quasi-linear degradation stage to an accelerated degradation phase, wherein the remaining useful life is determined during the accelerated degradation phase.

7. The method of claim 6, wherein determining the remaining useful life comprises extracting features from the condition-monitoring data and inputting the features to the hybrid model, the features comprising any combination of time domain features, frequency domain features, and time-frequency domain features.

8. The method of claim 1, further comprising:
estimating a first transition of the engineering system from a healthy stage to a quasi-linear degradation stage; and
estimating a second transition of the engineering system from the quasi-linear degradation stage to an accelerated degradation phase, wherein the remaining useful life estimation starts when the accelerated degradation phase is determined.

9. The method of claim 8, wherein a first health stage indicator is used to monitor the engineering system during the healthy stage, and where a different, second health stage indicator is used to monitor the engineering system during the accelerated degradation phase.

10. The method of claim 1, wherein the machine learning model comprises a feedforward, deep neural network.

11. The method of claim 10, wherein hyperparameters of the feedforward, deep neural network are determined using a grid search.

12. The computing system as set forth in claim 1, comprising a hardware processor and non-transitory memory that are operable via instructions to perform the method of claim 1.

13. A method implemented on a computing system comprising:
receiving condition-monitoring data of an engineering system at the computing system;
during a healthy stage of the engineering system, estimating a first health stage indicator of the engineering system based on the condition-monitoring data;
estimating a first transition of the engineering system from the healthy stage to a quasi-linear degradation stage using the first health stage indicator;
during the quasi-linear degradation stage, estimating a second health stage indicator of the engineering system using the condition-monitoring data that is different than the first health stage indicator;
estimating a second transition of the engineering system from the quasi-linear degradation stage to an accelerated degradation stage using the second health stage indicator; and
during the accelerated degradation stage:
inputting features extracted from the condition-monitoring data to a hybrid model;
applying mathematically parametrized transfer functions to intermediate variables of the hybrid model; and
estimating remaining useful life of the engineering system based on outputs of the mathematically parametrized transfer functions, the remaining useful life used to perform a remedial action on the engineering system.

14. The method of claim 13, wherein the intermediate variables of the hybrid model comprises a health indicator HI and a degradation progression rate c.

15. The method of claim 14, wherein the mathematically parametrized transfer functions comprise an exponential function.

16. The method of claim 15, further comprising imposing a constraint that the degradation progression rate c is assumed to be larger than one in a normalized health domain with upper and lower bounds of 1 and 0 respectively to impose convex degradation progression.

17. The method of claim 14, wherein applying the mathematically parametrized transfer functions to the intermediate variables of the hybrid model comprises:
applying a first transfer function that transfers the health indicator HI and the degradation progression rate c to a life domain using a physics-based relationship to obtain a first estimate of the remaining useful life;
applying a second transfer function that transfers the health indicator HI and the degradation progression rate c to the life domain using a linear relationship to obtain a second estimate of the remaining useful life; and
combining the first estimate and the second estimate using a weight to obtain a combined estimate of the remaining useful life.

18. The method of claim 13, wherein the features of the condition-monitoring data comprise any combination of time domain features, frequency domain features, and time-frequency domain features.

19. The method of claim 13, wherein the hybrid model comprises a feedforward deep neural network.

20. The computing system as set forth in claim 13, comprising a hardware processor and non-transitory memory that are operable via instructions to perform the method of claim 13.
